(19) United States
(12) Patent Application Publication
(10) Pub. No.: US 2009/0237225 A1
(43) Pub. Date: Sep. 24, 2009

(54) Supply line structure for transmitting information between motor-vehicle components

(76) Inventors: Thorsten Enders, Illingen (DE); Robert Hugel, Karlsruhe (DE); Juergen Schirmer, Heidelberg (DE); Frank Stiegler, Karlsruhe (DE); Klaus Dostert, Krickenbach (DE); Timo Kuhn, Ofigheim (DE)

Correspondence Address: KENYON & KENYON LLP, ONE BROADWAY, NEW YORK, NY, 10004, US

(21) Appl. No.: 12/455,401

(22) Filed: Jun. 1, 2009

Related U.S. Application Data
(63) Continuation of application No. 10/232,805, filed on Aug. 30, 2002, now abandoned.

(30) Foreign Application Priority Data
Aug. 31, 2001 (DE) DE 101 42 409.4

(51) Int. Cl. G05B 11/01

(52) U.S. Cl. 340/310.13

(57) ABSTRACT

A supply line structure for the energy supply of electrical components of a motor vehicle, and for transmitting information between at least a portion of the components. To reduce the interference susceptibility of the supply line structure in a Powerline Communications, and at the same time to continue to be able to ensure the energy supply of the electrical components via the supply line structure, it is provided that the supply line structure have separate supply lines, electrically isolated from the vehicle body, as return lines from the components to at least one energy source of the motor vehicle. The supply lines of the supply line structure preferably take the form of coaxial lines or twisted pair lines.

### FIELD OF THE INVENTION

The present invention relates to a supply line structure for supplying energy to electrical components of a motor vehicle, and for the transmission of information between at least a portion of the components.

### BACKGROUND INFORMATION

According to the related art, as a rule the communication in a motor vehicle between various electrical components such as, for example, the door control unit and seat control unit, takes place with the aid of a bus system (e.g. Controller Area Network, CAN). Moreover, new bus concepts are presently being developed in which the communication between the electrical components is intended to take place via a supply line structure that is provided for the energy supply of the electrical components in the motor vehicle. This new bus concept is also known as Powerline Communications. The Powerline Communications is only able to operate to a limited extent with the supply line structures existing in motor vehicles today, since because of interferences and reflections, the information to be transmitted over the supply lines arrives strongly damped at the receiving components, or even can no longer be differentiated from interference signals or noise signals.

PCT International Publication No. WO 92/21180 describes a supply line structure for Powerline Communications. In this document, the functioning method of the Powerline Communications is explained quite generally, and solutions are addressed for various problems which may occur when implementing the Powerline Communications. Reference is made specifically to this document with regard to the design of a supply line structure for the Powerline Communications, and with respect to the functioning method of the Powerline Communications.

Moreover, German Patent No. 197 03 144 describes a method for transmitting information in a motor vehicle via a supply line structure. The Powerline Communications described there is limited to use for electrical components of a back-up aid in a motor vehicle. The supply line structure already in the motor vehicle is used for the Powerline Communications without special changes or adaptations to the transmission of information.

### SUMMARY OF THE INVENTION

An object of the present invention is to provide a supply line structure of a motor vehicle in such a way as to ensure information transmission which is as undisturbed as possible between electrical components that are supplied with energy by the supply line structure. In particular, the intention is to reduce the interference susceptibility in a Powerline Communications. At the same time, the energy supply of the electrical components via the supply line structure should continue to be ensured.

To achieve this objective, starting from the supply line structure of the type indicated at the outset, the present invention provides that the supply line structure have separate supply lines, electrically isolated from the vehicle body, as return lines from the components to at least one energy source of the motor vehicle.

The measure of the present invention allows a decisive step in the direction of improving the interference immunity in a Powerline Communications in a motor vehicle. According to the present invention, it has been recognized that the design of the “return line” represents an important aspect with respect to the interference susceptibility of the supply line structure. Until now, the body of a motor vehicle has been used as a general electrical ground, which brings with it various unwanted effects in the high-frequency range, such as radio emission and crosstalk. The use of a vehicle-body ground is therefore no longer suitable for the reliable transmission of high-frequency information signals (transmission carried with high-frequency carriers) in Powerline Communications.

In Powerline Communications, information is no longer transmitted within a motor vehicle via data lines to be laid separately, but rather via the supply lines which are installed anyway in the motor vehicle for supplying energy to the components. Thus, in addition to being used for the energy supply, they are also used for transmitting information between the components. It is thereby possible to dispense with separate data lines as are necessary, for example, when working with a Controller Area Network (CAN) bus. This has essentially the following advantages:
Cost savings: In addition to the material costs for the data lines, the costs for laying the data lines are also saved.
Weight reduction: By the omission of the data lines, the total weight of the motor vehicle is reduced.
Low proneness to faults due to line defects: Reduction of the number of lines in critical regions having increased mechanical stress of the lines, e.g. in the area of movable vehicle parts such as doors, yields overall a lower proneness to faults with respect to line defects. Furthermore, the supply line structure, particularly for supplying energy to components in safety-relevant regions of the motor vehicle, is already designed to be so fail-safe that interruption of the energy supply for these components is nearly impossible. Loss of the energy supply for a safety-relevant component would endanger the safety of the motor vehicle, and must therefore absolutely be avoided using suitable safety measures.
Unification of existing bus concepts: Data transmission on the supply line structure permits a uniform transmission concept for all communication applications within the motor vehicle.
Easy retrofit capability: Because of the supply network generally already present in a motor vehicle, to which components and systems to be supplied with energy are connected, a communication network accessible at each of these components is available within the framework of Powerline Communications.

The information may be transmitted with the aid of multiple access methods, particularly by the TDMA (time division multiple access) method, FDMA (frequency division multiple access) method, or CDMA (code division multiple access) method. In these methods, the individual components are separated either in the time range or frequency range, or by the use of different (orthogonal) codes.

According to one advantageous further development of the present intention, the supply lines of the supply line structure take the form of coaxial lines or twisted pair lines. Coaxial lines are characterized by their good screening effect. The energy transport—no matter which frequency—takes place in the interior of the structure, so that no electromagnetic fields emerge. The cross-section of the coaxial lines must be large enough to be able to transport currents of over 25 A. The use of twisted pair lines represents a very attractive alternative to the coaxial structure.

According to one preferred specific embodiment of the present invention, it is provided that
all components are high-frequency decoupled from the supply line structure; and
transceivers are provided in the components, the impedance of the transceivers of the components being adapted to the characteristic impedance of the supply lines leading in each case to the components.

Reflections, which develop on the supply lines due to sudden changes in the characteristic impedance (transition points) or mismatching at the line ends, have a very disruptive effect for a rapid data transmission, since due to them, a long channel pulse response comes about. For this reason, if possible, each vehicle component is decoupled from the supply and data line in terms of high frequency. The channel characteristics of the information transmission may be decisively improved by these measures. In particular, a nearly constant damping characteristic and a reduction of the reflections in the supply line structure in terms of amount are attained. The information transmission thereby becomes predictable and calculable.

HF choke coils are advantageously arranged serially in the connecting lines, and at least one capacitor is parallel-connected in the connecting lines toward the components. This permits a particularly effective high-frequency decoupling of the electrical components. High frequencies are prevented from penetrating into the components. The parallel-connected capacitor produces a high-frequency short circuit.

According to a further preferred specific embodiment of the present invention, inserted between the components and the supply line structure is an adapter circuit by which the impedance of the transceivers of the components is adapted to the characteristic impedance of the supply lines leading in each case to the components. The impedance of the transceivers is matched to the characteristic impedance of the supply line. This is accomplished by a special adapter circuit which is made of two coils and a plurality of ferrite beads that are arranged in each of the supply lines, i.e. slipped concentrically onto the supply lines.

Finally, it is provided that the supply lines be arranged in an H-configuration, a ring configuration or a star configuration. In the case of the H-configuration, the cross-section of the main cable is adapted to the power to be transmitted. This means that the cross-section is the largest beginning at an energy source, and decreases with growing length, according to the number of components still to be supplied with energy. This would bring with it an additional saving in conductor material. In the ring configuration, the conductor cross-section, as in the H-configuration, may be variable according to the power to be transported. In this connection, in view of the high-frequency characteristic, it is important, in spite of the change in cross-section, to keep the characteristic impedance constant by formation of the conductor geometry. All in all, the effective line length will be higher by approximately the factor 2 than for the H-configuration. In the star configuration, the main cable has a constant cross-section. The individual supply line branches are dimensioned according to the specific energy requirements of the connected components.

### BRIEF DESCRIPTION OF THE DRAWINGS

FIG. 1 shows a supply line structure of the present invention according to one preferred specific embodiment.

FIG. 2 shows a transceiver unit of an electrical motor-vehicle component which is connected to the supply line structure of FIG. 1.

FIG. 3 shows an adapter circuit which is disposed between a branch of a supply line and electrical components connected to the supply line structure.

### DETAILED DESCRIPTION

The present invention provides various measures by which the properties of a supply line structure may be improved for transmitting information between electrical components of a motor vehicle that are connected to the supply line structure. In particular, the interference susceptibility of the information transmission may be reduced by a suitable design of the supply line structure. In addition, the channel characteristics of the information transmission may be improved by a high-frequency (HF) conditioning. This is achieved, for example, in that the damping characteristic is nearly constant, and the reflections are reduced in terms of amount.

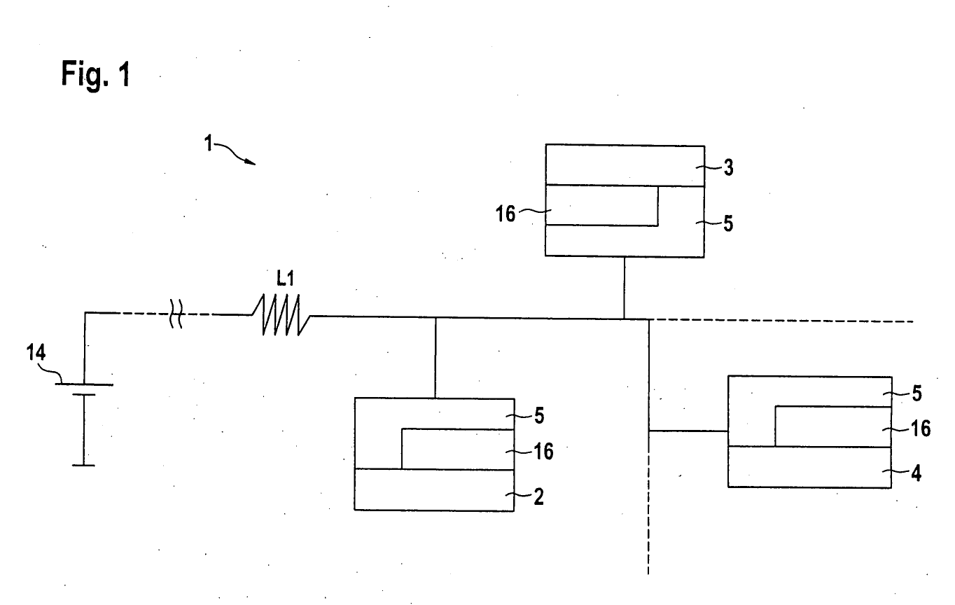

In FIG. 1, a supply line structure is designated in its entirety by reference numeral 1. Supply line structure 1 is actually provided for supplying energy to electrical motor-vehicle components 2, 3, 4. Also designated as electrical components 2, 3, 4 within the meaning of the present invention are hydraulic or pneumatic components which are electrically controllable and are supplied with energy via supply line structure 1. Electrical components 2, 3, 4 are, for example, motor-vehicle control units which are present in large number in modern motor vehicles and which must exchange information among themselves.

In FIG. 1, three components 2, 3, 4 are connected to supply line structure 1. However, it is conceivable to connect even more components to supply line structure 1 without difficulty, which is illustrated by the dotted line. In each component 2, 3, 4, a transceiver 5 is provided to transmit information from components 2, 3, 4 via supply line structure 1 and to receive information from supply line structure 1.

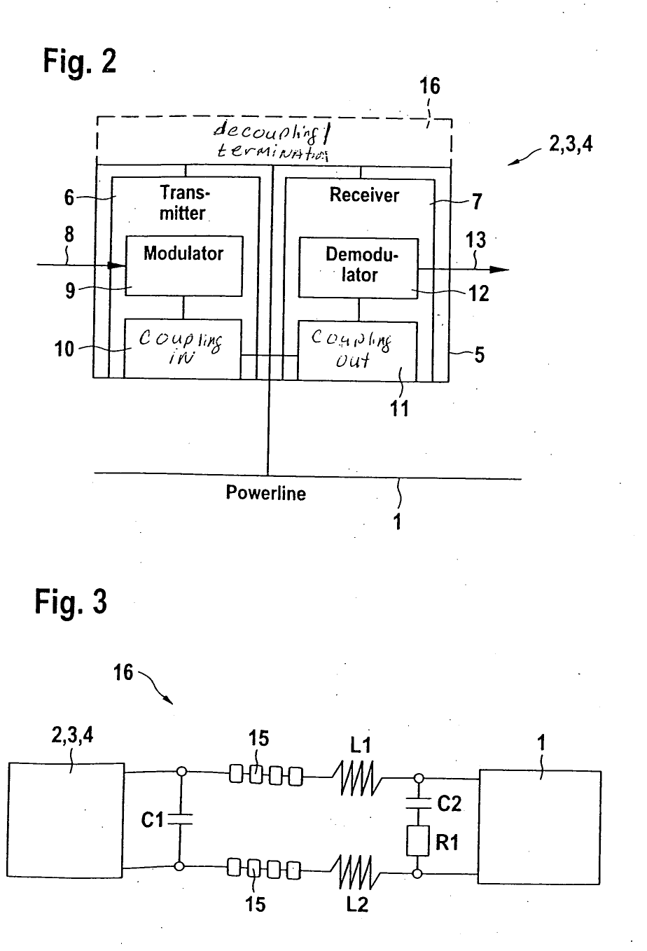

Transceiver 5 is shown in cut-away portion in FIG. 2. It includes a transmitter unit 6 and a receiver unit 7. Transmitter unit 6 receives information from components 2, 3, 4 which is to be transmitted via supply line structure 1. The information represents, for example, performance quantities of the motor vehicle received in components 2, 3, 4 by sensors 8. The information is transmitted with the aid of one or more carrier signals, i.e., the information to be transmitted is modulated upon the or each carrier. To that end, the information from sensors 8 is fed to a modulator 9.

In modulator 9, the information signal is modulated onto the carrier signal in a manner which corresponds to the transmission method desired. Single carrier methods with narrow-band modulation, spread spectrum methods or multi-carrier methods are used as transmission methods. Single carrier methods are, for example, ASK (amplitude shift keying), FSK (frequency shift keying), PSK (phase shift keying) in different variants such as BPSK, QPSK, DBPSK, DQPSK or QAM (quadrature amplitude modulation). DSSS (direct sequence spread spectrum) or FH (frequency hopping) are conceivable, for example, as spread spectrum methods.

Multi-carrier methods are, for example, OFDM (orthogonal frequency division multiplexing) with individual carrier modulation. When selecting the transmission method, attention must be paid to resistance with respect to existing interferers and to efficient utilization of the bandwidth available for the communication.

The carrier signal with the information signal modulated upon it is fed to a coupling-in device 10 which couples this signal into supply line structure 1. The modulated signal is thereupon transmitted via supply line structure 1. Preferably a frequency range between 100 MHz and 300 MHz is selected for the information transmission. Moreover, any other frequency ranges, for example, between 1 MHz and 10 MHz or 20 MHz may also be utilized.

In a receiving component 2, 3, 4, the modulated signal is first of all coupled out of supply line structure 1. To that end, a coupling-out device 11 is provided in receiver unit 7 of transceiver 5 of a component 2, 3, 4. The coupled-out signal is carried to a demodulator 12 in which the demodulation of the received signal, and thus the recovery of the transmitted information takes place. The received information is routed, for example, to actuators 13 in receiving components 2, 3, 4 for varying specific performance quantities or motor-vehicle functions.

For example, a carrier signal may have the form

u(t)=A(t)·cos [2πf(t)·t+φ(t)]

The information signal itself has, for example, the form

$$s ( t ) = {\sum }_{i = - ∞}^{∞} {b}_{i} \cdot rect ( \frac{t - i \cdot {T}_{b}}{{T}_{b}} )$$

In this context, bᵢ represents the information vector to be transmitted. T_{b} is the bit duration of a single data bit.

One or more parameters of the carrier wave may be varied as a function of information signal s(t). The possible parameters are amplitude A(t), frequency f(t) and phase □(t). The various transmission methods already indicated above result depending on the type of parameters influenced by information signal s(t).

On the basis of the information transmission at high frequencies, various modifications to supply line structure 1 and components 2, 3, 4 of the motor vehicle connected thereto must be carried out. They are, inter alia, a high-frequency decoupling of all components 2, 3, 4 of the motor vehicle from supply line structure 1, and adaptation of components 2, 3, 4 for the information transmission to the characteristic impedance of supply line structure 1.

To avoid unwanted and unforeseeable effects because of the high frequency, all components 2, 3, 4 are high-frequency decoupled. This means that the high frequency is not allowed to penetrate into components 2, 3, 4. This may be effected, for example, with high-frequency (HF) choke coils inserted serially into the supply lines, followed by a parallel-connected capacitor C1 (high-frequency short circuit) toward the component side. A suitable adapter circuit 16 for implementing this high-frequency decoupling is shown in FIG. 3.

Reflections, which develop on the supply lines due to sudden changes in the characteristic impedance (transition points) or mismatching at the line ends, have a disruptive effect for a rapid information transmission, since due to them, a long channel pulse response comes about. For this reason, if possible, each motor-vehicle component 2, 3, 4 is decoupled from supply line structure 1 in terms of high frequency, so that for the data transmission, components 2, 3, 4 may be adapted to the characteristic impedance of supply line structure 1. Adapter circuit 16 is made of two coils L1, L2 and a plurality of ferrite beads 15 which are slipped concentrically onto the supply line.

At high frequencies f>100 MHz, the impedance of a portion of the supply line provided with ferrite beads 15 according to FIG. 3 proves to be independent of frequency f. However, the impedance over the following exponential characteristic curve is dependent on the current load:

$$Z ( I ) = {Z}_{0} \cdot {e}^{\frac{I}{{I}_{0}}}$$

Reflections at the connecting points between supply line structure 1 and vehicle components 2, 3, 4 are avoided by the matching with resistor R1 (characteristic impedance of the supply line) shown. In the case of direct current, adapter circuit 16 in FIG. 3 has a very small volume resistance, in order to avoid additional losses in the energy transmission to components 2, 3, 4. At frequencies in the operating range of the Powerline Communications, however, a high through-put (volume) impedance is achieved which, if possible, contributes several times the characteristic impedance of the supply lines.

It is furthermore provided to modify supply line structure 1 as a further measure for improving the high-frequency transmission characteristic of the supply line structure. In addition to components 2, 3, 4, sudden changes in the characteristic impedance within the supply lines, which stem from line branches, lead to reflections. The following concepts would provide a solution for the redesign of supply line structure 1:
H-configuration: The cross-section of the main cable is adapted to the power to be transmitted. This means that, beginning at energy source 14 (motor-vehicle battery), the cross-section is the largest, and decreases with increasing length according to the number of components 2, 3, 4 still to be supplied with energy. This would bring with it an additional saving in conductor material (e.g. copper).
Ring configuration: The conductor cross-section is formed according to the H-configuration. In this connection, in view of the high-frequency characteristics, it is important, in spite of change in the cross-section, to keep the characteristic impedance constant by formation of the conductor geometry. On the whole, the effective line length will be higher by approximately the factor 2 than for the H-configuration.
Star configuration: The main cable has a constant cross-section. The individual supply lines to components 2, 3, 4 are dimensioned according to the specific energy demand of components 2, 3, 4.

A further important aspect for reducing the liability to interference in the transmission of information via supply line structure 1 is the formation of the “return line”. Until now, the body of a motor vehicle has been used as a general electrical ground, which brings with it various unwanted effects in the high-frequency range, for example, radio emission, crosstalk and reflections. Therefore, the use of a body ground is basically no longer suitable for reliable transmission of high-frequency signals. For this reason, it is provided to use separate supply lines, electrically isolated from the vehicle body, as return lines from components 2, 3, 4 to at least one energy source 14 of the motor vehicle.

The following concepts present themselves for the supply line structure with separate return line:
Design of supply line structure 1 as a coaxial line structure: Coaxial lines are distinguished by their good screening effect. The energy transport—no matter at what frequency—takes place in the interior of the structure, so that no electromagnetic fields can emerge. The coaxial structure requires a sufficiently large cross-section of the inner conductor, to be able to transport currents of over 25 ampere.
Design of supply line structure 1 with twisted pair lines.

The following multiple access methods present themselves as access method for the information transmission:
TDMA (Time Division Multiple Access)
FDMA (Frequency Division Multiple Access)
CDMA (Code Division Multiple Access)

In these methods, the individual communication partners (components 2, 3, 4) are either separated in time range or frequency range, or by the use of different (orthogonal) codes.

What is claimed is:

1. A supply line structure for the energy supply of electrical components of a motor vehicle and for transmitting information between at least a portion of the components, the motor vehicle including a vehicle body and at least one energy source, the supply line structure comprising:
separate supply lines, electrically isolated from the vehicle body, as return lines from the components to the at least one energy source of the motor vehicle.

2. The supply line structure according to claim 1, wherein the supply lines are coaxial lines.

3. The supply line structure according to claim 1, wherein the supply lines are twisted pair lines.

4. The supply line structure according to claim 1, wherein the components contain transceivers having an impedance adapted to a characteristic impedance of the supply lines, and wherein the components are high-frequency decoupled from the supply line structure.

5. A supply line structure for the energy supply of electrical components of a motor vehicle and for transmitting information between at least a portion of the components, the motor vehicle including a vehicle body and at least one energy source, the supply line structure comprising:
separate supply lines, electrically isolated from the vehicle body, as return lines from the components to the at least one energy source of the motor vehicle;
high-frequency choke coils situated serially in connecting lines; and
at least one capacitor parallel-connected in the connecting lines toward the components;
wherein the components contain transceivers having an impedance adapted to a characteristic impedance of the supply lines, and wherein the components are high-frequency decoupled from the supply line structure.

6. The supply line structure according to claim 4, wherein an adapter circuit is situated between the components and the supply line structure, the adapter circuit adapting the impedance of the transceivers of the components to the characteristic impedance of the supply lines.

7. The supply line structure according to claim 1, wherein the supply lines are situated in an H-configuration.

8. The supply line structure according to claim 1, wherein the supply lines are situated in a ring configuration.

9. The supply line structure according to claim 1, wherein the supply lines are situated in a star configuration.

10. The supply line structure according to claim 6, wherein the adapter circuit includes two coils and plurality of ferrite beads arranged in each of the supply lines.
